(19) United States
(12) Patent Application Publication
(10) Pub. No.: US 2025/0121331 A1
(43) Pub. Date: Apr. 17, 2025

(54) ACRYLATE ADHESIVE COMPOSITION FOR THE OUTER SHELL OF SPIRAL WOUND MEMBRANE FILTERS

(71) Applicant: H.B. Fuller Company, St. Paul, MN (US)

(72) Inventors: Kimberly M. Tucker, Saint Charles, IL (US); David H. Stenzel, Oakdale, MN (US); James P. Ryan, Omaha, NE (US)

(21) Appl. No.: 18/917,624

(22) Filed: Oct. 16, 2024

Related U.S. Application Data
(60) Provisional application No. 63/590,654, filed on Oct. 16, 2023.

(51) Int. Cl. B01D 63/10; B01D 69/14; B01D 71/40

(52) U.S. Cl. CPC B01D 63/10; B01D 69/1411; B01D 71/401; B01D 2313/042; B01D 2323/345

(57) ABSTRACT

The invention features a spiral wound membrane filter including an outer shell, the outer shell including a reinforcement material and an acrylate adhesive composition including a multifunctional (meth)acrylate, wherein the adhesive composition has a viscosity of no greater than 10,000 cP when measured at 23° C. according to ASTM D1084 Test Method B.

### CROSS REFERENCE TO RELATED APPLICATIONS

This application claims the benefit of U.S. Provisional Application No. 63/590,654, filed Oct. 16, 2023, and incorporated herein.

### BACKGROUND

The invention is directed to the use of acrylate adhesives to form the outer shell of a spiral wound membrane filter.

Two component epoxy-based adhesive compositions are commonly used as structural adhesives in filters. However, the cure time of two component epoxy-based adhesives can be up to 12 hours. There is a need for a structural adhesive for the outer shell of a spiral wound membrane filter that can cure quickly to allow for immediate handling of the filter.

### SUMMARY

In one aspect, the invention features a spiral wound membrane filter including an outer shell, the outer shell including a reinforcement material, and an acrylate adhesive composition comprising from 20% by weight to 90% by weight of a multifunctional (meth)acrylate, wherein the acrylate adhesive composition has a viscosity of no greater than 10,000 cP when measured at 23° C. according to ASTM D1084 Test Method B.

In one aspect, the invention features a spiral wound membrane including an outer shell, the outer shell including a reinforcement material, and an acrylate adhesive composition including 15% by weight to 60% by weight of a multifunctional (meth) acrylate oligomer, 30% by weight to 80% by weight of a (meth) acrylate monomer, and 0.2% by weight to 5% by weight of a photo initiator, wherein the acrylate adhesive composition has a viscosity of no greater than 10,000 cP when measured at 23° C. according to ASTM D1084 Test Method B.

In one embodiment, the acrylate adhesive composition has a viscosity of no greater than 5,000 cP when measured as 23° C. according to ASTM D1084 Test Method B. In another embodiment, the acrylate adhesive composition has a viscosity of no greater than 2,500 cP when measured as 23° C. according to ASTM D1084 Test Method B. In another embodiment, the acrylate adhesive composition has a Shore D Hardness of from D60 to D100 as tested according to the Shore D Hardness test method. In one embodiment, the multifunctional (meth) acrylate is selected from the group consisting of a multifunctional (meth) acrylate oligomer, a (meth)acrylate monomer and combinations thereof. In a different embodiment, the multifunctional (meth) acrylate oligomer is selected from the group consisting of urethane acrylate, epoxy acrylate, polyester acrylate, acrylic acrylate, polyether acrylates, polybutadiene acrylate and combinations thereof. In another embodiment, the multifunctional (meth) acrylate oligomer includes an aliphatic urethane acrylate. In one embodiment, the (meth)acrylate monomer includes an isobornyl acrylate monomer. In a different embodiment, the (meth) acrylate monomer includes at least two (meth) acrylate monomers.

In a different embodiment, the at least two (meth)acrylate monomers include a monofunctional monomer and a multifunctional monomer.

In one embodiment, the acrylate adhesive composition further includes an initiator selected from the group consisting of photo initiators, thermal initiators, and combinations thereof. In another embodiment, the acrylate adhesive composition includes a photo initiator the initiator including at least two different photo initiators.

In a different embodiment, the reinforcement material is selected from the group consisting of a continuous strand, a web, a scrim, and a nonwoven fabric. In another embodiment, the reinforcement material is a continuous fiberglass strand.

In one aspect, the invention features a method of making the outer shell of a spiral wound membrane filter including the following steps: obtaining an acrylate adhesive composition including a multifunctional (meth)acrylate and an initiator, passing at least one continuous strand of reinforcement material through the acrylate adhesive composition, wrapping the continuous strand around the outside circumference, along the entire length of the spiral wound membrane filter and exposing the continuous strand of reinforcement material coated with the acrylate adhesive composition to an energy source at a time selected from during wrapping, after wrapping and a combination thereof.

In one embodiment, the continuous strand of reinforcement material is fiberglass. In another embodiment, the energy source is selected from the group consisting of ultraviolet light, visible light, electron beam radiation, microwave radiation, heat, and a combination thereof. In a different embodiment, the energy source is selected from the group consisting of ultraviolet light, visible light, heat, and a combination thereof.

The outer shell of a spiral wound membrane filter is often formed by winding fiberglass coated in uncured liquid resin (e.g., a 2-part epoxy) around spiral wound separator elements. The filter is then allowed to cure at room temperature or exposed to higher temperature to expedite the cure. The equipment required to mix and pump the 2-part epoxy and the time required to cure the final filter adds time and cost to the process and thus the final filter.

The invention features an acrylate adhesive composition that has the required properties to be used to form the outer shell of a spiral wound membrane filter.

Other features and advantages will be apparent from the following description of the preferred embodiments, and the claims.

### Glossary

In reference to the invention, the following terms have the meanings set forth below:

As used herein, the term “(meth)acrylate” is a shorthand reference meaning acrylate, methacrylate, or a combination thereof.

As used herein, the term “multifunctional (meth)acrylate” means a (meth)acrylate that includes at least two (meth)acrylate groups.

[symbol]

As used herein “ultraviolet light” is defined as having a wavelength of from 100 nanometers (nm) to 405 nm.

As used herein “visible light” is defined as having a wavelength of from >405 nm to 760 nm.

### DETAILED DESCRIPTION

### Spiral Wound Membrane Filter

In membrane filtration, filter elements (e.g., semi-permeable membranes) are used to remove impurities from a liquid. Membrane filtration can be used for a wide variety of applications, including applications selected from the group consisting of reverse osmosis, forward osmosis, nanofiltration, ultrafiltration and microfiltration

Spiral wound filter elements are formed by winding one or more membrane envelopes and optional feed channel spacer sheets around a center core collection tube in a spiral fashion. Each membrane envelope preferably comprises two substantially rectangular membrane sheets surrounding a permeate channel spacer sheet. This sandwich structure is secured together by an adhesive along three edges while the fourth edge is firmly against the permeate collection tube so that the permeate spacer is in fluid contact with openings passing through the permeate collection tube. The liquid to be filtered enters the membrane module from one end. Once inside the module, filtration occurs when pressure is applied to drive the clean liquid through the membrane surface. Coming out the module on the other end, clean liquid travels through the center core collection tube where it has been collected and a concentrated waste liquid passes through the membranes. The spiral wound membrane filter can further include end caps at the ends of the filter to help hold the membranes in place.

Spiral wound membrane filters come in a variety of sizes. For larger filters, in some cases having a diameter of greater than 2-4 inches, an outer shell surrounds the outer circumference of the filter to help maintain the shape of the filter and protect it.

The invention features a spiral wound membrane filter including an outer shell, the outer shell including a reinforcement material and an acrylate adhesive composition including a multifunctional (meth)acrylate, wherein the adhesive composition has a viscosity of no greater than 10,000 cP when measured at 23° C. according to ASTM D1084 Test Method B.

The invention features a spiral wound membrane filter including an outer shell, the outer shell including a reinforcement material and an acrylate adhesive composition including from 20% by weight to 90% by weight of a multifunctional (meth)acrylate, wherein the adhesive composition has a viscosity of no greater than 10,000 cP when measured at 23° C. according to ASTM D1084 Test Method B.

In one aspect, the invention features a spiral wound membrane filter including an outer shell, the outer shell including a reinforcement material, and an acrylate adhesive composition comprising from 5% by weight to 90% by weight of a multifunctional (meth)acrylate, wherein the acrylate adhesive composition has a viscosity of no greater than 10,000 cP when measured at 23° C. according to ASTM D1084 Test Method B.

The invention features a spiral wound membrane filter including an outer shell, the outer shell including a reinforcement material and an acrylate adhesive composition including a multifunctional (meth)acrylate, and a photo initiator, wherein the adhesive composition has a viscosity of no greater than 10,000 cP when measured at 23° C. according to ASTM D1084 Test Method B.

The invention also features a spiral wound membrane filter comprising an outer shell, the outer shell including a reinforcement material, and an acrylate adhesive composition including 15% by weight to 60% by weight of a multifunctional (meth) acrylate oligomer, 30% by weight to 80% by weight of a (meth) acrylate monomer, and 0.5% by weight to 5% by weight of a photo initiator, wherein the adhesive composition has a viscosity of no greater than 10,000 cP when measured at 23° C. according to ASTM D1084 Test Method B.

The invention provides a new way to form the outer shell of a spiral wound membrane filter that is simpler (one-part instead of two-part), faster and provides the required strength and hardness.

### Outer Shell

The outer shell surrounds the outer circumferential surface of the membrane filter and helps to maintain the shape of and protect the filter. The outer shell includes reinforcement material and an acrylate adhesive composition. The acrylate adhesive composition in the shell is cured by exposing the composition to an energy source. The energy source can be selected from the group consisting of ultraviolet light, visible light, electron beam radiation, microwave radiation, heat, and a combination thereof. Alternatively, the energy source can be selected from the group consisting of ultraviolet light, visible light, heat and a combination thereof.

The acrylate adhesive composition can be cured as the shell is being made, after the shell is made, or a combination thereof. When the process used to cure the acrylate adhesive composition includes exposing the composition to light, the acrylate adhesive composition can include a photo initiator. When the process used to cure the acrylate adhesive composition includes heating the acrylate adhesive composition, the acrylate adhesive composition can include a thermal initiator. The acrylate adhesive composition can include both a thermal initiator and a photo initiator.

### Reinforcement Material

The reinforcement material can be in a form selected from the group consisting of a continuous strand, a web, a scrim, and a nonwoven fabric. The reinforcement material is most commonly a continuous strand. The reinforcement material can be selected from the group consisting of fiberglass, carbon fiber, aramid (e.g., Kevlar) or any other material that when combined with the adhesive creates a tough burst proof shell to protect the filter.

### Acrylate Adhesive Composition

The adhesive composition is a one-part, 100% solids acrylate adhesive composition. In one embodiment, the acrylate adhesive composition does not include isocyanate functionality. The acrylate adhesive composition includes a multifunctional (meth) acrylate. The acrylate adhesive composition can include from 15% by weight to 90% by weight of a multifunctional (meth)acrylate. The acrylate adhesive composition can include a multifunctional (meth)acrylate, and a photo initiator. The acrylate adhesive composition can include 15% by weight to 60% by weight of a multifunctional (meth) acrylate oligomer, 30% by weight to 80% by weight of a (meth) acrylate monomer, and 0.5% by weight to 5% by weight of the photo initiator

The acrylate adhesive composition is hard enough to provide a strong shell for the filter. The acrylate adhesive composition can have a Shore D Hardness of greater than 60, greater than 65, greater than 70, from 50, 55, 60, 65 to 85, 90, 95, 100 or any two values therebetween.

The acrylate adhesive composition can have a viscosity of no greater than 10,000 cP, no greater than 7,500 cP, no greater than 5,000 cP, no greater than 2,500 cP, no greater than 1,500 cP, from 10 cP to 10,000 cP, from 10 cP to 7,500 cP, from 10 cP to 2,500 cP, from 10 cP to 1500 cP, from 50 cP to 1200 cP, or even from 250 cP to 1200 cP, when measured at 23° C. by ASTM D1084 Test Method B. The lower viscosity is particularly beneficial when the reinforcement material is a strand that is coated with the acrylate adhesive composition and wound around the outside of the membrane.

### Multifunctional (Meth)Acrylate

The multifunctional (meth)acrylate includes at least two ethylenically unsaturated functional groups. Preferably at least two of the ethylenically unsaturated functional groups are located at the terminal ends of the multifunctional (meth)acrylate. The multifunctional (meth) acrylate can be selected from the group consisting of oligomers, monomers and combinations thereof.

The acrylate adhesive composition can have a multifunctional (meth) acrylate content of from 5% by weight, 10% by weight, 15% by weight, 20% by weight, 25% by weight, 30% by weight, 35% by weight, 40% by weight, 45% by weight to 70% by weight, 75% by weight, 80% by weight, 85% by weight, 90% by weight, 95% by weight, or any two values therebetween.

### Multifunctional (Meth)Acrylate Oligomer

The acrylate adhesive composition includes a multifunctional (meth)acrylate oligomer. The acrylate adhesive composition can include more than one (meth)acrylate oligomer. The multifunctional (meth)acrylate oligomer can be selected from the group consisting of urethane, ester, epoxy, and butadiene (meth)acrylate oligomers.

In an aspect of the present invention, the (meth) acrylate oligomer is a polyether or polyester urethane acrylate oligomer. The (meth)acrylate-functionalized polyether or polyester urethane component can be synthesized by reacting diisocyanate with a polyether or polyester polyol to yield an isocyanate-terminated urethane. The isocyanate-terminated urethane is then reacted with a hydroxy-terminated acrylate to provide acrylate groups at the ends of the oligomer. The multifunctional (meth)acrylate oligomer can be completely reacted such that there are no free isocyanate groups. Alternately, if the terminal isocyanates are not completely reacted with the hydroxy acrylate, isocyanates will remain in the structure as reactive groups in addition to the acrylate terminal groups. This can be helpful if additional strength is needed.

Multifunctional (meth)acrylate oligomers are commercially available under a variety of trade designations including, e.g., GENOMER4316, GENOMER 4215, GENOMER 4267, GENOMER 2235, GENOMER 2281, GENOMER 2263 and GENOMER 3486 all available from RAHN USA Corp (Aurora, Illinois) and EBERCRYL 8465 and EBERCRYL 8411 available from Allnex Netherlands B.V.

The acrylate adhesive composition includes from 5% by weight, 10% by weight, 15% by weight, 20% by weight, 25% by weight, 30% by weight, 35% by weight to 40% by weight, 50% by weight, 55% by weight, 60% by weight, 65% by weight, 70% by weight, 75% by weight or any two values there between of a (meth)acrylate oligomer based on the weight of the components in the acrylate adhesive composition.

### (Meth)Acrylate Monomer

The (meth)acrylate monomer can be multifunctional (difunctional, trifunctional, etc.) or monofunctional. The (meth)acrylate monomer can function as a diluent and can be used to adjust the viscosity of the acrylate adhesive composition. The acrylate adhesive composition can include more than one (meth)acrylate monomer, for example the adhesive composition can include a blend of multifunctional and monofunctional monomers.

The (meth)acrylate monomer includes at least one ethylenically unsaturated functional group, or even at least two ethylenically unsaturated functional groups.

Suitable monofunctional (meth)acrylate monomers include, e.g., methyl (meth)acrylate, isopropyl (meth)acrylate, isobutyl (meth)acrylate, tert-butyl (meth)acrylate, steryl (meth)acrylate, 2-hexyl (meth)acrylate, octyl (meth)acrylate, isooctyl (meth)acrylate, decyl (meth)acrylate, isodecyl (meth)acrylate, dodecyl (meth)acrylate, tetradecyl(meth)acrylate, phenoxyethyl (meth)acrylate, tetrahydrofurfuryl (meth)acrylate, glycidyl (meth)acrylate, hydroxyethyl (meth)acrylate, hydroxypropyl (meth)acrylate, hydroxybutyl (meth)acrylate, benzyl (meth)acrylate, dicyclopentyl (meth)acrylate, and combinations thereof.

Suitable multifunctional (meth)acrylate monomers include, e.g., ethylene glycol di(meth)acrylate, diethylene glycol di(meth)acrylate, triethylene glycol di(meth)acrylate, dipropylene glycol di(meth)acrylate, 1,3-butylene glycol di(meth)acrylate, 1,4-butanediol di(meth)acrylate, 1,6-hexanediol di(meth)acrylate, neopentyl glycol di(meth)acrylate, cyclohexane dimethanol di(meth)acrylate, dicyclopentyl di(meth)acrylate, glyceryl tri(meth)acrylate, trimethylolpropane tri(meth)acrylate, pentaerythritol tri(meth)acrylate, pentaerythritol tetra(meth)acrylate, dipentaerythritol penta(meth)acrylate, hexafunctional aliphatic acrylate monomer, tris(2-hydroxy ethyl) isocyanurate tri(meth)acrylate, alkoxylated versions of the same, and combinations thereof.

The (meth)acrylate monomer can be an aliphatic acrylate. An aliphatic acrylate can be helpful to improve the water resistance of the acrylate adhesive composition and thus the shell. The (meth)acrylate monomer can be selected from the group consisting of isobornyl acrylate, polyether acrylate, tricyclodecane dimethanol diacrylate and hexafunctional aliphatic acrylate.

The (meth)acrylate monomer can exhibit a viscosity of no greater than 1,500 cP, no greater than 1,000 cP, no greater than 500 cP, no greater than 150 cP, from 5 cP to 1,500 cP, or even from 5 cP to 1,000 cP at 25° C.

(Meth)acrylate monomers are commercially available under a variety of trade designations including, e.g., GENOMER 1121Y, GENOMER 7302, MIRAMER M262 and MIRAMER M600 all available from RAHN USA Corp (Aurora, Illinois).

The acrylate adhesive composition includes from 5% by weight, 10% by weight, 15% by weight, 20% by weight, 25% by weight, 30% by weight, 35% by weight to 40% by weight, 50% by weight, 55% by weight, 60% by weight, 65% by weight, 70% by weight, 75% by weight or any two values there between of a (meth)acrylate monomer based on the weight of the components in the acrylate adhesive composition.

### Initiator

The acrylate adhesive composition optionally includes an initiator. Useful initiators include thermal initiators, photo initiators, and mixtures thereof.

Useful thermal initiators have a ten hour half-life at a temperature of no greater than 70° C., no greater than 60° C., no greater than 50° C., no greater than 40° C., no greater than 30° C. or even from about 30° C. to about 70° C. Useful classes of thermal initiators include, e.g., organic peroxides (e.g., di(4-tert-butylcyclohexyl) peroxydicarbonate, tert-butyl peroxyneodecanoate, di(2-ethylhexyl) peroxydicarbonate), benzoyl peroxide, lauroyl peroxide, 2,2-azo-bisisobutyronitrile, t-butyl peroxypivalate, α,α′-Bis(neodecanoyl peroxy) diisopropyl benzene, cumyl peroxy neodecanoate, t-hexyl peroxypivalate, 1,1,3,3-tetramethylbutyl peroxy neodecanoate, 1,1,3,3-tetramethylbutyl peroxy 2-ethylhexanoate, t-amyl peroxypivalate, t-amyl peroxy neodecanoate, isobutyryl peroxide, succinic peroxide, 3,5,5-trimethylhexanoyl peroxide, di-methoxybutyl peroxydicarbonate, di-(sec-butyl) peroxydicarbonate, t-butyl peroxyncoheptanoate, di-(3,5,5-trimethylhexanoyl) peroxide, di-(sec-butyl) peroxydicarbonate, and combinations thereof.

Suitable thermal initiators are commercially available under a variety of trade designations including, e.g., PERKADOX 16 di(4-tert-butylcyclohexyl) peroxydicarbonate and TRIGONOX 23 tert-butyl peroxyncodecanoate both of which are available Nouryon Chemical (Chicago, Illinois), PEROXAN EPC di(2-ethylhexyl)peroxydicarbonate) from Pergan Marshall LLC (Marshall, Texas), under the VAZO series of trade designations from DowDuPont (Wilmington, Delaware), and under the CHEMEX series of trade designations from (Hosung Chemex Co, Ltd. (Seoul, Korea) including CHEMEX 2EHPC, BND series, BPV series, CND70 (IP), OND, TMPO, AND, and APV.

The acrylate adhesive composition includes from 0% by weight to no greater than 10% by weight, at least about 1% by weight, no greater than 5% by weight, no greater than 3% by weight, from about 1% by weight to about 5% by weight, or even from about 2% by weight to about 4.5% by weight thermal initiator.

It can be useful to include more than one, or even two photo initiators in the acrylate adhesive composition.

Useful photo initiators include, e.g., 2-hydroxy-2-methyl-1-phenyl-propan-1-one, 2,2-dimethoxy-1,2-diphenylethan-1-one, 1-hydroxy cyclohexyl phenylketone, 2,4,6-trimethylbenzoyl-diphenyl-phosphineoxide, benzophenone, benzoin, benzoin ethers (e.g., benzoin methyl ether and benzoin isopropyl ether), substituted benzoin ethers (e.g., anisoin methyl ether), substituted acetophenones (e.g., 2,2-diethoxyacetophenone and 2,2-dimethoxy-2-phenylacetophenone), substituted alpha-ketols (e.g., 2-methyl-2-hydroxypropiophenone), aromatic sulfonyl chlorides (e.g., 2-naphthalenesulfonyl chloride), photoactive oximes (e.g., 1-phenyl-1,2-propanedione-2-(O-ethoxycarbonyl) oxime), methylbenzoylformate and mixtures thereof.

Suitable photo initiators are commercially available under a variety of trade designations including, e.g., under the OMNIRAD series of trade designations from IGM Resins (Waalwijk, The Netherlands) including OMNIRAD 73 2-hydroxy-2-methyl-1-phenylpropanone, under the DAROCUR series of trade designations from BASF Corporation (Florham Park, New Jersey) including DAROCUR TPO 2,4,6-trimethylbenzoyl-diphenyl-phosphineoxide, under the IRGACURE series of trade designations from BASF Corporation including, e.g., IRGACURE 651 and IRGACURE TPO, and under the ESACURE series of trade designations from IGM Resin (Waalwijk, Netherlands) including ESACURE KB-1 benzildimethylketal and under the GENOCURE series of trade designation from RAHN USA Corp (Aurora, Illinois) including GENOCURE BAPO, GENOCURE TPO-L, and GENOCURE MBF.

The acrylate adhesive composition includes from 0% by weight to no greater than 10% by weight, no greater than 5% by weight, no greater than 3% by weight, from 0.2% by weight to about 5% by weight, or even from 0.5% by weight to 5% by weight of a photo initiator.

### Additives

Various additives may be included in the acrylate adhesive composition including, e.g., adhesion promoters (e.g., silane adhesion promoters), antioxidants, rheology modifiers, inhibitors, defoamers, optical brighteners, antioxidants, dyes, pigments, and combinations thereof.

Useful adhesion promoters include, e.g., silanes, isocyanate containing compounds, titanates, zirconates, phosphates, epoxy-containing compounds, epoxy (meth)acrylate hybrid monomers and oligomers, and combinations thereof. Examples of useful epoxy-containing compounds include (e.g., silsesquioxane, epoxy silane, epoxy resins (e.g., Bisphenol A diglycidyl ether and Bisphenol F diglycidyl ether), epoxy phenolic novolac resins, epoxy cresol novolac resins, cycloaliphtic epoxies, and combinations thereof. Useful epoxy silane adhesion promoters are available under the SILQUEST series of trade designations from Momentive Performance Materials Inc. (Waterford, New York) including SILQUEST A187 alkoxy silane epoxy adhesion promoter.

### Additional Materials

The acrylate adhesive composition can also include additional materials. Additional materials can be liquid or solid at room temperature. Additional materials include other polymers, oligomers and monomers (e.g., (meth)acrylate polymers that are non-reactive (i.e. no (meth)acrylate functionality remaining), vinyl acetate polymers, core-shell polymers, synthetic rubber polymers (e.g., polybutadiene and butadiene-acrylonitrile copolymers) having carboxyl-, amino-, vinyl-(meth)acrylic-, or epoxy-functionality, or a combination of such functionalities or any other compatible polymer, etc.) and plasticizers.

Useful additional polymers are available under the ELVACITE trade designation from Mitsubishi Chemical UK Ltd. and under the DEGALAN trade designation from Roehm America LLC.

### Method of Making a Spiral Wound Filter Shell

The invention features a method of making the outer shell of a spiral wound membrane filter including the following steps: obtaining an acrylate adhesive composition including a multifunctional (meth)acrylate and an initiator, passing at least one continuous strand of reinforcement material through the acrylate adhesive composition, wrapping the continuous strand around the outside circumference, along the entire length of the spiral wound membrane filter and exposing the continuous strand of reinforcement material coated with the acrylate adhesive composition to an energy source at a time selected from during wrapping, after wrapping and a combination thereof.

The invention also features a method of making the outer shell of a spiral wound membrane filter comprising the following steps: obtaining an acrylate adhesive composition comprising a multifunctional (meth)acrylate and a photo initiator, passing at least one continuous strand of reinforcement material through the acrylate adhesive composition, wrapping the at least one continuous strand around the outside circumference, of the entire length, of a spiral wound membrane filter, and exposing the continuous strand of reinforcement material coated with the acrylate adhesive composition to an energy source at a time selected from during wrapping, after wrapping and a combination of both.

The method includes coating at least one continuous strand of reinforcement material with the acrylate adhesive composition. To improve the speed of the process any number of strands (e.g., more than one strand, even from 2 to 20, or even 2 to 10 strands) can be coated and wrapped at the same time. The method can optionally include the removal of excess acrylate adhesive composition either directly after coating, after wrapping or after both.

The energy source can be selected from the group consisting of ultraviolet light, visible light, electron beam radiation, microwave radiation, heat, and a combination thereof Alternatively, the energy source can be selected from the group consisting of ultraviolet light, visible light, heat, and a combination thereof.

The invention will now be described by way of the following examples. All parts, ratios, percentages and amounts stated in the Examples are by weight unless otherwise specified.

### EXAMPLES

### Test Procedures

Test procedures used in the examples include the following. All ratios and percentages are by weight unless otherwise indicated. The procedures are conducted at room temperature (i.e., an ambient temperature of from about 20° C. to about 25° C.) unless otherwise specified.

### Test Sample Preparation Method

The samples were prepared in the following way. The oligomers are warmed at 60° C. for two hours then added to a clean mixing vessel. An overhead shear blade was lowered into the oligomer and turned on to “medium” for 10 minutes. Monomer was then weighed and added slowly to the oligomer. The sample was then mixed under medium high shear for two hours or until homogenous.

In a separate container the powdered photo initiator was added to the diluent (monofunctional) monomer and placed under another mixer for 15 minutes. The diluent monomer/photo initiator mixture is then added to the original container. The combined mixture is blended for 30 minutes. The second photo initiator is added and mixed for 15 minutes. The blend is tested for viscosity and diluent monomer is added for adjustments.
Viscosity was tested according to ASTM D1084 Test Method B.
Shore D Hardness was tested according to ASTM D2240.

The liquid acrylate adhesive was poured into a 5.08 cm (2 inch)×5.08 cm (2 inch) weighing dish to a depth of 0.635 cm (0.25 inches). The sample was then cured under a UVA lamp for 30 seconds and allowed to cool before testing.

### Moisture Absorption was Tested According to ASTM D570

6 grams of the liquid acrylate adhesive was poured into a 50.8 mm diameter metal weighing dish. It was then cured under UVA for 30 seconds. Once cooled, it was removed from the tray. The cured thickness was at least 3.2 mm. The sample was allowed to sit at room temperature for 24 hours before beginning test.

Tensile Properties were Tested According to ASTM D638 in the Following Way.

The liquid acrylate adhesive was poured into ASTM D638 Type IV Teflon molds to create specimens that were approximately 2 mm thick. The specimens were cured under UVA lamp for 30 seconds. They were then allowed to sit at ambient conditions for at least 24 hour prior to testing. Samples were pulled using an Instron set to an extension rate of 5 millimeters (mm)/min. The average of 5-8 samples was reported.

TABLE ONE

| | Ex 1 | Ex 2 | Ex 3 | Ex 4 | Ex 5 | Ex 6 | Ex 7 | Ex 8 | Ex 9 |
|---|---|---|---|---|---|---|---|---|---|
| EBECRYL 8411 | | | | | 48.25 | | | | |
| aliphatic urethane diacrylate | | | | | | | | | |
| oligomer | | | | | | | | | |
| GENOMER 4215 | | | | 34.3 | | | | | |
| aliphatic polyester urethane | | | | | | | | | |
| diacrylate oligomer | | | | | | | | | |
| GENOMER 4267 | | | 41.01 | | | 17.1 | | | |
| aliphatic urethane diacrylate | | | | | | | | | |
| oligomer | | | | | | | | | |
| GENOMER 4316 | 41.3 | 40.3 | | | | | | | |
| aliphatic polyester urethane | | | | | | | | | |
| diacrylate oligomer | | | | | | | | | |
| EBECRYL 8465 | | | | 7 | | | | | |
| aliphatic urethane triacrylate | | | | | | | | | |
| oligomer | | | | | | | | | |
| GENOMER 2235 aliphatic | | | | | | 44.6 | | | |
| epoxy acrylate oligomer | | | | | | | | | |
| GENOMER 2281 epoxy acrylate | | | | | | | 43.2 | | |
| oligomer | | | | | | | | | |
| GENOMER 2263 epoxy acrylate | | | | | | | | 39.2 | 25.6 |
| oligomer | | | | | | | | | |
| GENOMER 3486 polyester | | | | | | | | | 37.6 |
| acrylate oligomer | | | | | | | | | |
| GENOMER 1121Y | 29.7 | 24.7 | 40.47 | 42.8 | 32.76 | 21 | 37.5 | 33 | 18.6 |
| isobornyl acrylate monomer | | | | | | | | | |
| (functionality = 1) | | | | | | | | | |
| GENOMER 7302 | 8.7 | 15 | | | | | | 8.3 | |
| polyether acrylate monomer | | | | | | | | | |
| (functionality = 3) | | | | | | | | | |
| MIRAMER M262 | 17.4 | 7 | 15.62 | 14 | 16.09 | 14.4 | 16.4 | 16.6 | 15.3 |
| tricyclodecane dimethanol | | | | | | | | | |
| diacrylate monomer | | | | | | | | | |
| (functionality = 2) | | | | | | | | | |
| MIRAMER M600 | | 10 | | | | | | | |
| hexafunctional aliphatic acrylate | | | | | | | | | |
| monomer | | | | | | | | | |
| GENOCURE BAPO | 0.9 | | 0.9 | 0.9 | 0.9 | 0.9 | 0.9 | 0.9 | 0.9 |
| phosphine oxide photo initiator | | | | | | | | | |
| GENOCURE MBF | | 1.0 | | | | | | | |
| methylbenzoylformate | | | | | | | | | |
| photoinitiator | | | | | | | | | |
| GENOCURE TPO-L | 2.0 | 2.0 | 2.0 | 1.0 | 2.0 | 2.0 | 2.0 | 2.0 | 2.0 |
| phosphine oxide photo initiator | | | | | | | | | |
| Viscosity @ 23° C. (cP) | 900 | 800 | 1000 | 1100 | 900 | 900 | 800 | 900 | 900 |
| Shore D Hardness | 74 | 81 | 75 | 74 | 64 | 78 | 82 | 75 | 75 |
| Moisture Absorption | 2.6 | 1.9 | 2.7 | 1.7 | 1.8 | 4.7 | 1.6 | 1.2 | 2.4 |
| (weight %) | | | | | | | | | |
| Automatic Young's Modulus | 1081 | 730 | 1055 | 637 | 918 | 1373 | 2145 | 1908 | 1692 |
| (MPa) | | | | | | | | | |
| Tensile Stress at Break (MPa) | 41 | 33 | 43 | 26 | 34 | 9.5 | 14.8 | 13.2 | 11.7 |
| Tensile Strain at Break (%) | 7.3 | 12 | 9.8 | 12.9 | 7.9 | 8.1 | 9.1 | 4.7 | 4.3 |

1. A spiral wound membrane filter comprising an outer shell, the outer shell comprising:
a. a reinforcement material, and
b. an acrylate adhesive composition comprising a multifunctional (meth) acrylate, wherein the acrylate adhesive composition has a viscosity of no greater than 10,000 cP when measured at 23° C. according to ASTM D1084 Test Method B.

2. The spiral wound membrane filter of claim 1 wherein the acrylate adhesive composition comprises:
a. 15% by weight to 60% by weight of a multifunctional (meth) acrylate oligomer,
b. 30% by weight to 80% by weight of a (meth) acrylate monomer, and
c. 0.2% by weight to 5% by weight of a photo initiator.

3. The spiral wound membrane filter of claim 1 wherein the acrylate adhesive composition has a viscosity of no greater than 2,500 cP when measured as 23° C. according to ASTM D1084 Test Method B.

4. The spiral wound membrane filter of claim 1 wherein the acrylate adhesive composition has a viscosity of no greater than 1,500 cP when measured as 23° C. according to ASTM D1084 Test Method B.

5. The spiral wound membrane filter of claim 1 wherein the acrylate adhesive composition has a Shore D Hardness of from 60 to 100 as tested according to the Shore D Hardness test method.

6. The spiral wound membrane filter of claim 1 wherein the multifunctional (meth) acrylate is selected from the group consisting of (meth) acrylate oligomer, (meth)acrylate monomer and combinations thereof.

7. The spiral wound membrane filter of claim 2 wherein the multifunctional (meth) acrylate oligomer is selected from the group consisting of urethane acrylate, epoxy acrylate, polyester acrylate, acrylic acrylate, polyether acrylate, polybutadiene acrylate and combinations thereof.

8. The spiral wound membrane filter of claim 2 wherein the multifunctional (meth) acrylate oligomer comprises an aliphatic urethane acrylate.

9. The spiral wound membrane filter of claim 2 wherein the (meth)acrylate monomer comprises an aliphatic acrylate.

10. The spiral wound membrane filter of claim 2 wherein the (meth)acrylate monomer comprises isobornyl acrylate monomer.

11. The spiral wound membrane filter of claim 2 wherein the (meth) acrylate monomer comprises at least two (meth) acrylate monomers.

12. The spiral wound membrane filter of claim 11 wherein the at least two (meth)acrylate monomers comprise a monofunctional monomer and a multifunctional monomer.

13. The spiral wound membrane filter of claim 1 wherein the reinforcement material is a continuous fiberglass strand.

14. The spiral wound membrane filter of claim 1 wherein the acrylate adhesive composition is a one part having 100% solids.

15. A method of making the outer shell of a spiral wound membrane filter comprising the following steps:
a. obtaining an acrylate adhesive composition comprising a multifunctional (meth)acrylate and an initiator having a viscosity of no greater than 10,000 cP when measured at 23° C. according to ASTM D1084 Test Method B,
b. passing at least one continuous strand of reinforcement material through the acrylate adhesive composition,
c. wrapping the continuous strand around the outside circumference, along the entire length of the spiral wound membrane filter, and
d. exposing the continuous strand of reinforcement material coated with the acrylate adhesive composition to an energy source at a time selected from during wrapping, after wrapping and a combination thereof.

16. The method of claim 15 wherein the continuous strand of reinforcement material is fiberglass, and the energy source is selected from the group consisting of ultraviolet light, visible light, heat, and a combination thereof.

17. The method of claim 15 wherein the acrylate adhesive composition comprises:
a. 15% by weight to 60% by weight of a multifunctional (meth) acrylate oligomer,
b. 30% by weight to 80% by weight of a (meth) acrylate monomer, and
c. 0.2% by weight to 5% by weight of a photo initiator.

18. The method of claim 15 wherein the acrylate adhesive composition has a viscosity of no greater than 2,500 cP when measured as 23° C. according to ASTM D1084 Test Method B.

19. The method of claim 15 wherein the energy source is selected from the group consisting of ultraviolet light, visible light, and a combination thereof.

20. The spiral wound membrane filter of claim 2 wherein the multifunctional (meth)acrylate oligomer is selected from and the group consisting of urethane acrylate, epoxy acrylate, polyester acrylate, acrylic acrylate, polyether acrylate, polybutadiene acrylate and combinations thereof and the (meth)acrylate monomer comprises an aliphatic acrylate.
